(19) United States
(12) Patent Application Publication
(10) Pub. No.: US 2026/0112734 A1
(43) Pub. Date: Apr. 23, 2026

(54) BATTERY PACK HOUSING HAVING PLATE ASSEMBLY WITH AIR PASSAGES AND FINS

(71) Applicant: FCA US LLC, Auburn Hills, MI (US)

(72) Inventors: Zachary Cook, Auburn Hills, MI (US); Nicolas Bertier, Auburn Hills, MI (US)

(21) Appl. No.: 18/919,519

(22) Filed: Oct. 18, 2024

(51) Int. Cl. H01M 10/6561; B60H 1/00; B60K 11/06; B60L 50/64; H01M 10/613; H01M 10/625; H01M 10/647; H01M 10/653; H01M 10/6551; H01M 10/663; H01M 50/209; H01M 50/224; H01M 50/289

(52) U.S. Cl. CPC H01M 10/6561; B60H 1/00278; B60K 11/06; B60L 50/64; H01M 10/613; H01M 10/625; H01M 10/647; H01M 10/653; H01M 10/6551; H01M 10/663; H01M 50/209; H01M 50/224; H01M 50/289; B60H 2001/003; H01M 2220/20

(57) ABSTRACT

A battery pack assembly that communicates with a heating ventilation and air conditioning (HVAC) system for an electrified vehicle is provided. The battery back assembly includes a battery pack housing and a plurality of battery cells. The battery pack housing includes a plate assembly and a plurality of fins. The plate assembly comprises a first plate that defines a first air passage therethrough and a second plate that defines a second air passage therethrough. The fins are connected to and extend between the first and second plates. The plurality of battery cells are disposed in the battery pack housing. A first battery cell is positioned between adjacent fins. Heat generated from the plurality of battery cells is transferred (i) conductively to the fins and to the plate assembly; and (ii) convectively from the plate assembly to the air travelling through the first and second air passages.

### FIELD

The present application generally relates to electrified vehicles and, more particularly, to a battery pack assembly having a battery pack housing including a plate assembly with air passages and fins to support cooling and heating of the battery pack assembly.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack assembly that includes a housing that houses one or more battery packs. Thermal management is critical during operation of the battery pack assembly. In some examples, the battery pack assembly is air cooled. In some arrangements, a heating cooling and ventilation (HVAC) system can be used to provide air cooling to the battery pack assembly. Such systems can provide air cooling properties but are complicated and generally inefficient. Accordingly, while such battery pack assembly air cooled configurations do work well for their intended purpose, there is a desire for improvement in the relevant art.

### SUMMARY

According to one example aspect of the invention, a battery pack assembly that communicates with a heating ventilation and air conditioning (HVAC) system for an electrified vehicle is provided. The battery back assembly includes a battery pack housing and a plurality of battery cells. The battery pack housing includes a plate assembly and a plurality of fins. The plate assembly comprises at least a first plate that defines a first air passage therethrough and a second plate that defines a second air passage therethrough, wherein the first and second air passages receive air from the HVAC system. The plurality of fins are connected to and extend between the first and second plates. The plurality of battery cells are disposed in the battery pack housing. A first battery cell of the plurality of battery cells is positioned between adjacent fins of the plurality of fins. Heat generated from the plurality of battery cells is transferred (i) conductively to the fins and to the plate assembly; and (ii) convectively from the plate assembly to the air travelling through the first and second air passages.

In some implementations, the air travelling through the first and second air passages is confined by the plate assembly such that it is precluded from directly interfacing with the cells of the plurality of battery cells.

In some implementations, the first and second air passages define elongated ducts that extend laterally across the battery pack housing.

In some implementations, the battery pack housing further comprises an outer box that houses the plate assembly and the plurality of battery cells.

In some implementations, the plate assembly and outer box are formed of aluminum.

In additional aspects, the battery pack housing further comprises first thermal insulating material disposed between adjacent fins of the plurality of fins and battery cells of the plurality of battery cells.

In additional features, the battery pack housing further comprises second thermal insulating material disposed between battery cells of the plurality of battery cells and the first and second plates.

In other features, the plate assembly further comprises a third plate that defines a third air passage therethrough, wherein the third air passage receives the air from the HVAC system.

In additional arrangements, the second plate is arranged between the first and the third plates in the battery pack housing.

In some examples, battery cells of the plurality of battery cells are disposed between the first and second plates and between the second and third plates.

In implementations, the plurality of fins are connected to and extend between the second and third plates.

In examples, the outer box is welded to the plate assembly.

In other examples, the battery pack housing further comprises foam disposed between adjacent fins of the plurality of fins.

In other implementations, the first and second air passages extend from first and second air inlets to first and second air outlets, wherein the first and second air inlets receive the air from an air tunnel defined between a vehicle frame and an underbody plate.

In other examples, the air exits the battery pack housing from the first and second air outlets and flows through a remainder of the HVAC system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly including a battery pack housing having a plate assembly with air passages and fins to support cooling and heating of the battery pack assembly according to various principles of the present application; and

FIG. 2 is a side view of the battery pack housing of FIG. 1 and showing an exemplary air path from an HVAC system according to various principles of the present application;

FIG. 3 is a front view of the battery pack housing of FIG. 2 illustrating a plurality of inlet air passages according to features of the present application;

FIG. 4 is a sectional view taken along lines 4-4 of FIG. 2 illustrating a plurality of battery cells according to various principles of the present application; and

FIG. 5 is a detail view of FIG. 4 according to various principles of the present application.

### DESCRIPTION

As discussed above, a high voltage battery system generally includes a battery pack assembly that includes a housing that houses one or more battery packs. Thermal management is critical during operation of the battery pack assembly. In some examples, the battery pack assembly is air cooled. In some arrangements, a heating cooling and ventilation (HVAC) system can be used to provide air cooling to the battery pack assembly. Such systems can provide air cooling properties but are complicated and generally inefficient.

The instant disclosure provides a battery pack assembly having a battery pack housing including a plate assembly with air passages and fins to support cooling and heating of the battery pack assembly. The plate assembly defines air passage inlets that receive air from an HVAC system of the electrified vehicle. The plate assembly includes fins that engage a plurality of battery cells. The fins physically support the battery cells for a cell-to-pack battery cell layout that reduces component count and allows for a reduction in mass and cost of the overall battery pack cooling system. The plate assembly uses both convective and conductive heat transfer.

In examples, the plate assembly is formed of light weight conductive material such as aluminum. By arranging the fins between adjacent battery cells, thermal management is enhanced by leveraging aluminum's high thermal conductivity for efficient heat dissipation. The battery pack housing described herein provides a more uniform cooling across the battery pack thereby reducing hot spots and improving overall performance. The surface area of the fins provides improved heat transfer to the surrounding air while also providing structural rigidity and protection to the battery cells.

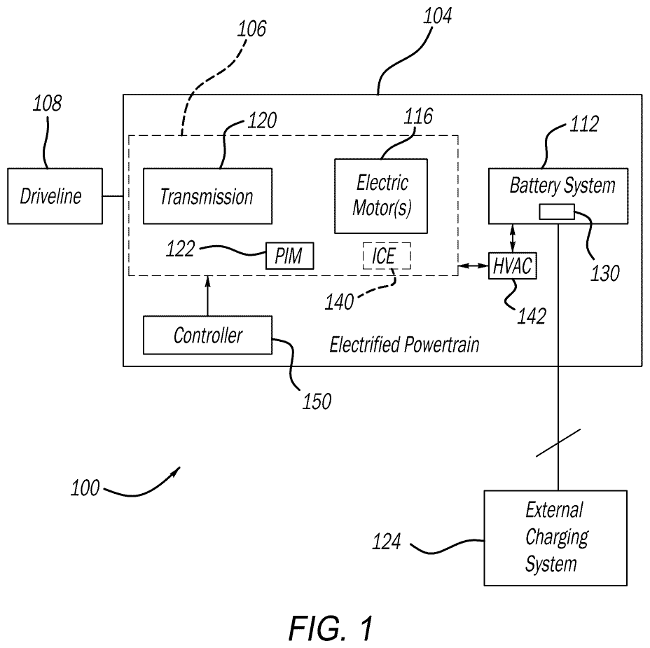

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. In some examples, the electrified powertrain 104 can by a hybrid powertrain that additionally includes an internal combustion engine 140. A heating cooling and air conditioning (HVAC) system 142 can provide communicate air to various systems of the electrified vehicle 100 such as to the EDM 106 and the battery system 112. A controller 150 can provide various inputs to the EDM 106 related to selectively switching power inputs between the electric motors 116 and the ICE 140.

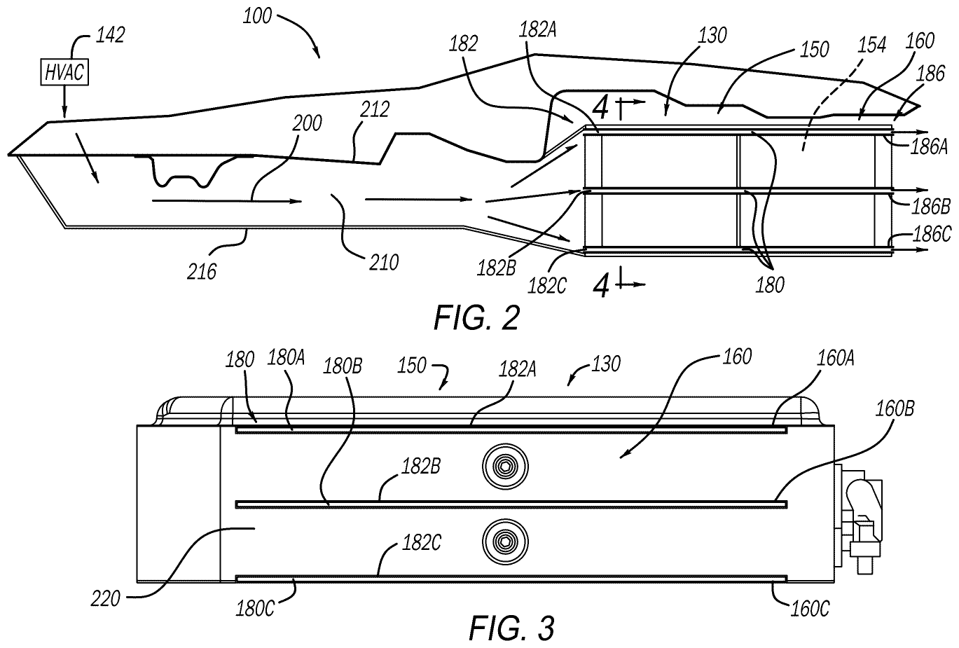

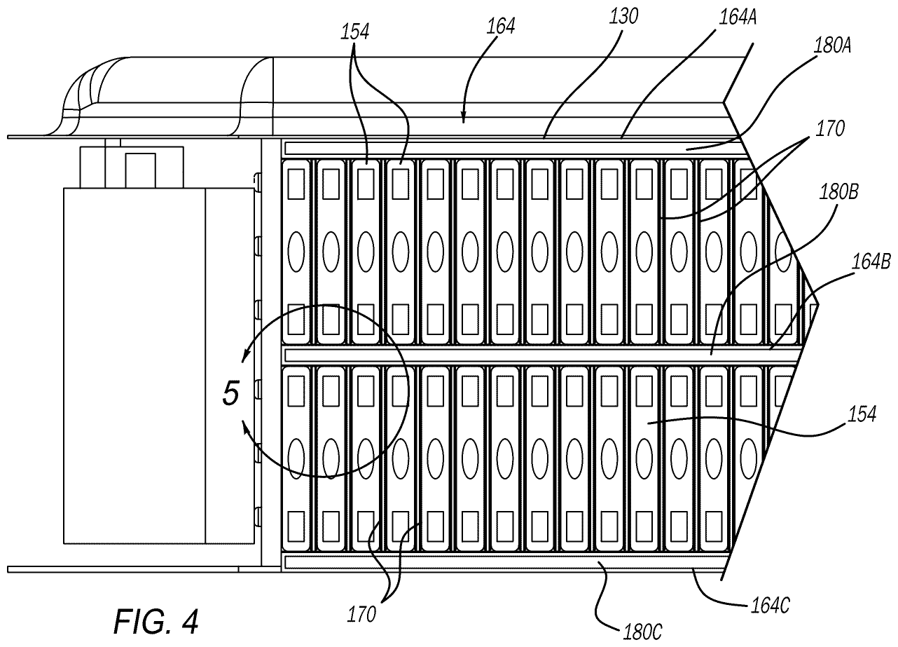

With additional reference now to FIGS. 2-5, additional features of the battery pack assembly 130 will be further described. The battery pack assembly 130 generally includes a battery pack housing 150 that houses a plurality of battery cells, collectively identified at reference numeral 154, and individually identified at reference numerals 154A-154F. The battery cells 154 are structurally supported by a plate assembly 160 within the battery pack housing 150. The exemplary plate assembly 160 includes a plurality of plates, collectively identified at reference numeral 164 and individually identified at reference numerals 164A-164C.

A plurality of fins, collectively identified at reference 170, and individually identified at reference 170A-170H extend from the plurality of plates 164. The respective plurality of plates 164 and fins 170 are connected together to assist in thermal conduction as will become further appreciated herein. The plate assembly 160 is formed of a lightweight conductive material such as aluminum. The heat generated by the battery cells 154 is passed to the plate assembly 160 through the fins 170.

The plates 164A-164C of the plate assembly 160 each define air passages or channels, collectively identified at reference 180 and individually identified at 180A-180C. The air channels 180A-180C generally extend through the respective plates 164A-164C from air inlets, collectively identified at reference numeral 182 and individually identified at reference 182A-182C to air outlets, collectively identified at reference numeral 186A-186C. In examples, the air channels 180 define elongated ducts that extend laterally across a width of the battery pack housing 150 that aligns with the battery cells 154.

Air 200 is communicated from the HVAC 142 and delivered through an air tunnel 210 generally defined between a vehicle floor or frame 212 and a vehicle underbody plate 216. The air 200 enters the plate assembly 160 generally at the air passage inlets 182A-182C where it flows along the respective plates 160A-160C. As the fins 170 physically engage the battery cells 154 and the plates 160 (through thermal interface material discussed below), heat generated by the battery cells 154 is transferred (conductively) to the fins 170 and to the plates 160. Air 200, passing through the air channels 180, (convectively) removes the heat from the surfaces of the plates 164. The air 200 exits the battery pack housing 150 at the outlets 186 where it flows to a remainer of the HVAC system (e.g., vehicle cabin, etc.). The configuration of the plate assembly 160 is such that the air 200 simply flows through the air channels 180 and never directly engages the battery cells 154.

With reference to FIG. 3, the battery pack housing 150 can be formed of aluminum. The battery pack housing 150 can further comprise an outer box 220 that is thermally connected (e.g., welded) to the plate assembly 160. In examples, the outer box 220 can be formed of aluminum extrusion.

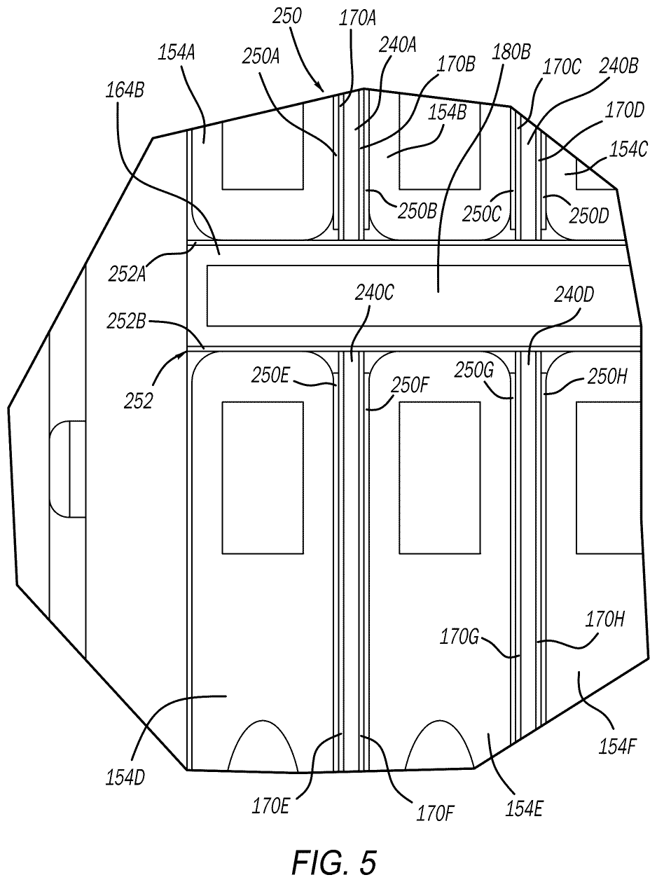

Turning now to FIG. 5, additional features of the plate assembly 160 will be further described. Foam, collectively identified at 240, and individually identified at reference 240A-240D is disposed between adjacent fins 170. The foam 240 is used to assist in breathing and/or swelling of the battery cells 154. First thermal interface material, collectively identified at 250, and individually identified at reference 250A-250H is disposed between the battery cells 154 and the fins 170. Second thermal interface material, collectively identified at 252, and individually identified at reference 252A-252B is disposed between the plates 164 and the battery cells 154.

The heat generated by the battery cells 154 is ultimately conductively passed to the plates 164, and then convectively dissipated from the plates 164 through the air 200 flowing through the passages 180. Explained further, the heat of the battery cells 154 is initially concurrently transferred (i) through the first thermal interface material 250, then to the fins 170 and subsequently to the plates 164; and (ii) through the second thermal interface material 252 to the plates 164. As discussed above, the plates 164 are cooled by the air 200 coming from the HVAC 142 and flowing through the passages 180 defined in the plate assembly 160.

The battery pack housing provides many improvements. For example, mass, cost and complexity is reduced over conventional air cooled battery systems. Thermal transfer properties are enhanced as compared to conventional air cooled battery systems. Energy is increased over conventional air cooled battery systems. Structural integrity is improved for the battery pack housing as a whole in part due to the plate assembly and fins. The fins provide increased surface area for improved heat transfer from the adjacent battery cells. The aluminum structure adds rigidity and protection for the battery cells enhancing durability at the cell level. Battery cells are removed from modules and are integrated, and physically supported within the battery pack housing. The cooling system effectively serves multi-functions including as a support structure for the battery cells, a battery cell spacer, a cooling and heating component, and increased protection from impact scenarios.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery pack assembly that communicates with a heating ventilation and air conditioning (HVAC) system for an electrified vehicle, the battery pack system comprising:
a battery pack housing comprising:
a plate assembly having at least a first plate that defines a first air passage therethrough and a second plate that defines a second air passage therethrough, wherein the first and second air passages receive air from the HVAC system;
a plurality of fins connected to and extending between the first and second plates; and
a plurality of battery cells disposed in the battery pack housing, wherein a first battery cell of the plurality of battery cells is positioned between adjacent fins of the plurality of fins;
wherein heat generated from the plurality of battery cells is transferred (i) conductively to the fins and to the plate assembly; and (ii) convectively from the plate assembly to the air travelling through the first and second air passages.

2. The battery pack assembly of claim 1, wherein the air travelling through the first and second air passages is confined by the plate assembly such that it is precluded from directly interfacing with the cells of the plurality of battery cells.

3. The battery pack assembly of claim 1, wherein the first and second air passages define elongated ducts that extend laterally across the battery pack housing.

4. The battery pack assembly of claim 1, wherein the battery pack housing further comprises:
an outer box that houses the plate assembly and the plurality of battery cells.

5. The battery pack assembly of claim 4, wherein the plate assembly and outer box are formed of aluminum.

6. The battery pack assembly of claim 1, wherein the battery pack housing further comprises:
first thermal insulating material disposed between adjacent fins of the plurality of fins and battery cells of the plurality of battery cells.

7. The battery pack assembly of claim 6, wherein the battery pack housing further comprises:
second thermal insulating material disposed between battery cells of the plurality of battery cells and the first and second plates.

8. The battery pack assembly of claim 1, wherein the plate assembly further comprises:
a third plate that defines a third air passage therethrough, wherein the third air passage receives the air from the HVAC system.

9. The battery pack assembly of claim 8, wherein the second plate is arranged between the first and the third plates in the battery pack housing.

10. The battery pack assembly of claim 9, wherein battery cells of the plurality of battery cells are disposed between the first and second plates and between the second and third plates.

11. The battery pack assembly of claim 10, wherein the plurality of fins are connected to and extend between the second and third plates.

12. The battery pack assembly of claim 5, wherein the outer box is welded to the plate assembly.

13. The battery pack assembly of claim 1, wherein the battery pack housing further comprises:
foam disposed between adjacent fins of the plurality of fins.

14. The battery pack assembly of claim 1, wherein the first and second air passages extend from first and second air inlets to first and second air outlets, wherein the first and second air inlets receive the air from an air tunnel defined between a vehicle frame and an underbody plate.

15. The battery pack assembly of claim 14, wherein the air exits the battery pack housing from the first and second air outlets and flows through a remainder of the HVAC system.
